(19) United States
(12) Patent Application Publication
(10) Pub. No.: US 2016/0023700 A1
(43) Pub. Date: Jan. 28, 2016

(54) Kit for and Method of Converting a Vehicle

(71) Applicant: William F. Dugan, Waterloo, NE (US)

(72) Inventor: William F. Dugan, Waterloo, NE (US)

(73) Assignee: Fleet Systems, Inc., Fremont, NE (US)

(21) Appl. No.: 14/789,758

(22) Filed: Jul. 1, 2015

Related U.S. Application Data
(60) Provisional application No. 62/019,871, filed on Jul. 1, 2014.

(51) Int. Cl. B62D 65/02; A61G 21/00

(52) U.S. Cl. CPC B62D 65/024; A61G 21/00

(57) ABSTRACT

Shown and described are a kit for and method of converting a vehicle into a hearse including a method of converting an interior, a method of converting an exterior, a kit for converting an interior and a kit for converting an exterior.

### REFERENCE TO EARLIER APPLICATION

This Application incorporates by reference and, under 35 U.S.C. §119(e), claims priority to US Provisional Patent Application Serial No. 62019871 filed on Jul. 1, 2014.

### STATEMENT REGARDING FEDERALLY SPONSORED RESEARCH OR DEVELOPMENT

This invention is not the subject of federally sponsored research or development.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

Vehicles adapted to be used as hearses typically are constructed on a chassis supplied by Lincoln, Cadillac or other luxury car manufacturer. The chassis typically must be cut, altered and/or stretched with numerous changes by a conversion company. These modifications are not inexpensive, and often result in a vehicle with body, drivetrain or electrical problems.

Other vehicles used in the transport of dead bodies include vans. Vans typically do not have to be modified, but also do not provide desirable carrying capacity or functionality, reverential conveyance of the deceased.

The invention overcomes the foregoing with a conversion that does not require structural alterations to the vehicle chassis. The invention preserves the integrity, safety and reliability that would be expected from a production vehicle and provides optimal carrying capacity and usability than the aforementioned altered vehicles at considerably less cost.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is an exterior top front right side elevational view of a vehicle appropriate for conversion with an embodiment of a kit and according to an embodiment of a method of converting a vehicle configured according to principles of the invention;

FIGS. 2A and 2B respectively are interior rear top right side and front top left side elevational views of the vehicle of FIG. 1;

FIG. 3 is a schematic view of an embodiment of a method of converting a vehicle configured according to principles of the invention;

FIGS. 4A and 4B are plan views of an embodiment of a kit for converting a vehicle configured according to principles of the invention;

FIGS. 5-7 respectively are an interior rear and side views of the vehicle of FIG. 1 including components of the kit of FIG. 4 incorporated according to the method of FIG. 3;

FIG. 8 is a plan view of an embodiment of a kit for converting a vehicle configured according to principles of the invention;

FIG. 9 is an exterior top front right side elevational view of the vehicle of FIG. 1 including components of the kit of FIG. 8 incorporated according to the method of FIG. 3;

FIG. 10 is a plan view of clips for installing components of the kit of FIGS. 4 and 8; and

FIG. 11 is an interior rear left elevational view of the vehicle of FIG. 1 including components of the kit of FIG. 4 incorporated according to the method of FIG. 3.

### DETAILED DESCRIPTION OF THE PREFERRED EMBODIMENTS

This disclosure is not limited in application to the details of construction and the arrangement of components set forth or illustrated in the drawings herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described or illustrated are intended to exemplify embodiments of the disclosure. However, alternative mechanical or electrical configurations are possible, which are considered to be within the teachings of the disclosure. Furthermore, unless otherwise indicated, “or” is to be considered inclusive.

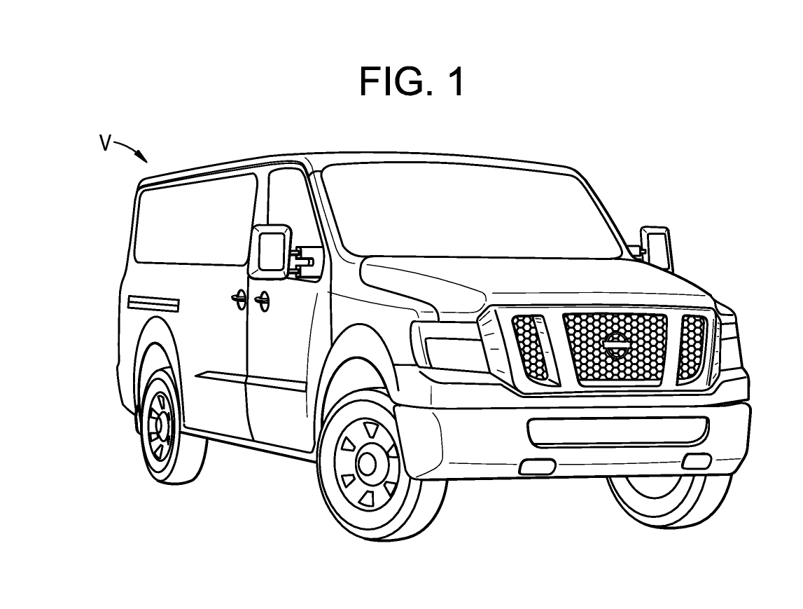

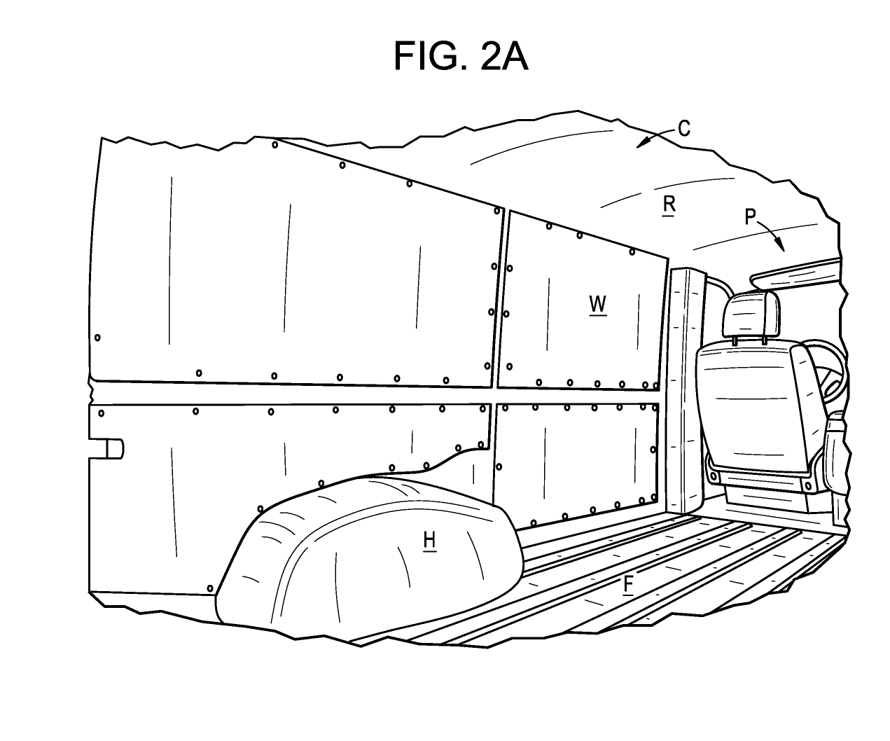

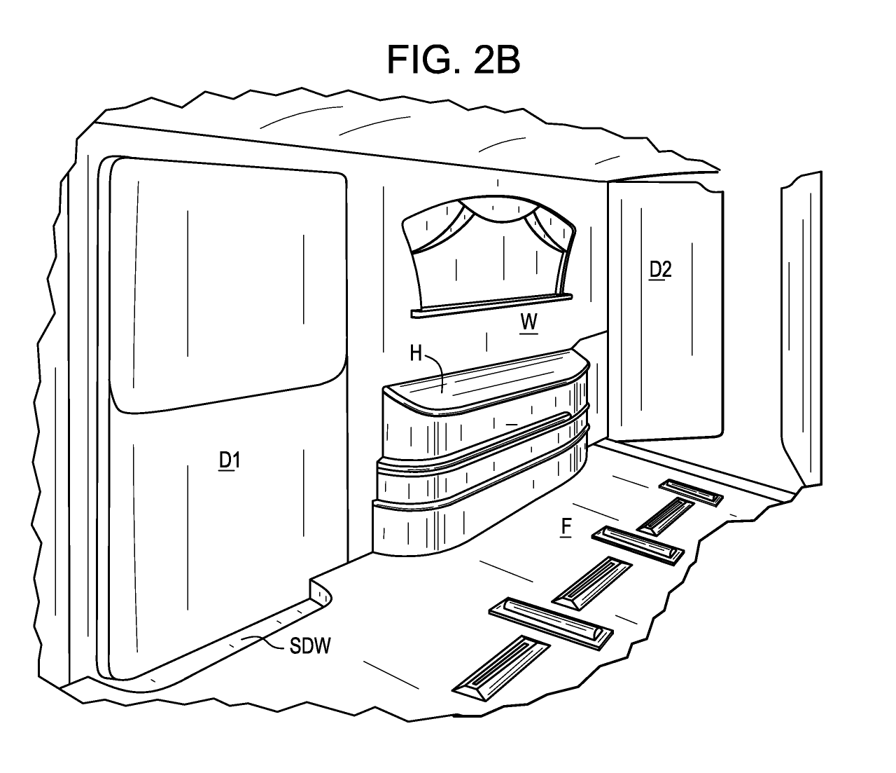

The invention includes a kit for and method of converting a vehicle into a hearse. FIGS. 1 and 2 respectively show the exterior and interior cargo area C of the preferred vehicle V, a standard Nissan NV van (1500, 2500, 3500) that is intended for conversion with the present kit according to the present method. The method 100 of converting a vehicle includes a method 200 of converting an interior and a method 300 of converting an exterior. The kit 400 for converting a vehicle includes a kit 500 for converting an interior and a kit 600 for converting an exterior.

While the steps of the methods herein are described in order of preference, rigid adherence to the order is not critical to the invention.

Referring to FIGS. 2-4, the method 200 for converting the interior includes a step 205 of providing instructions 503 of a kit 501 for converting an interior of a vehicle. Instructions 503 explain method 200 as set forth herein.

Vehicle V, as obtained, may present cargo area C with seating, trim and other installations (not shown). In that case, method 200 advances to step 210 of removing nonessential structure from cargo area C, including, but not limited to seating, trim and other installations, thereby appearing as shown in FIG. 2. Thus, prior to further steps, cargo area C should present a floor F, walls W, wheel wells H, roof R and doors D1 and D2. As shown, floor F extends to, but not into passenger compartment P, which is shown containing a seat S and other installations.

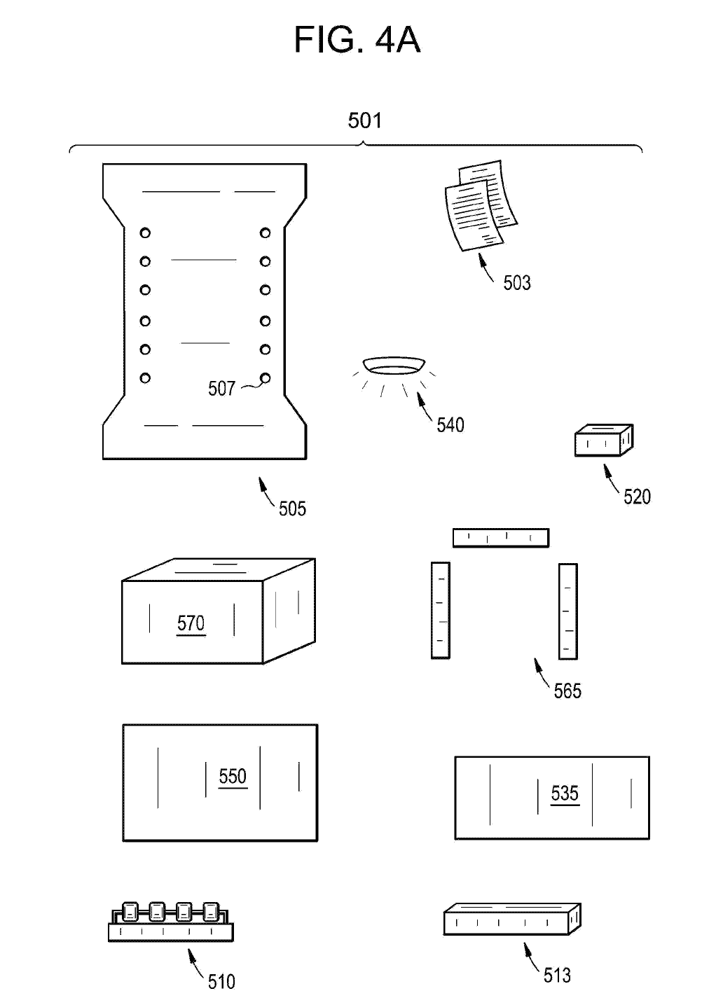

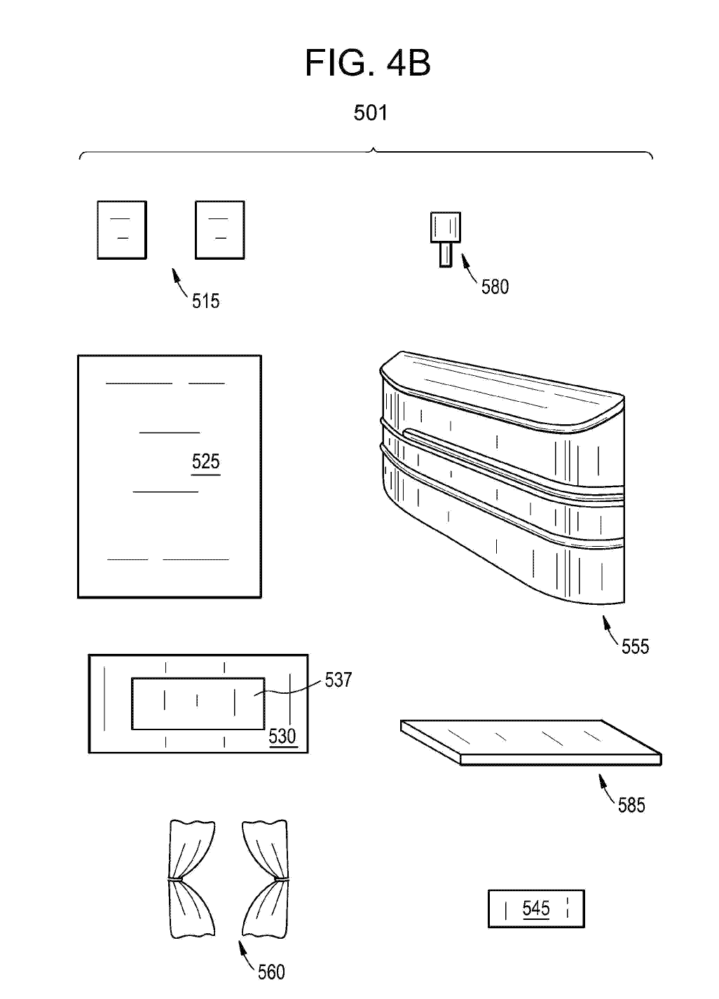

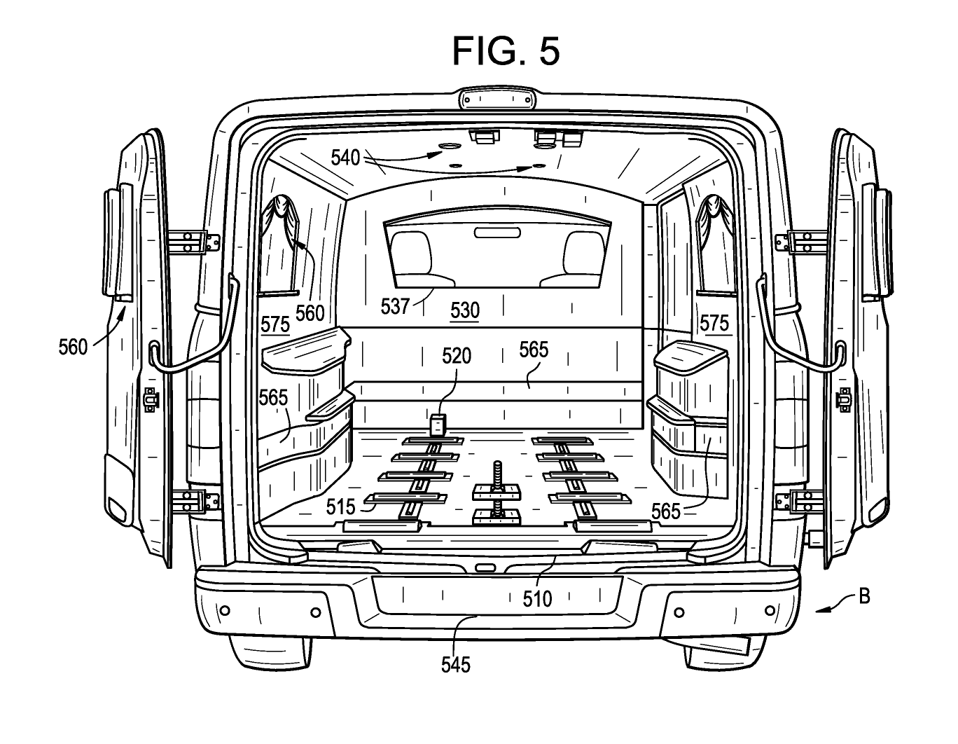

With cargo area C stripped of all but essential structure, referring also to FIGS. 4 and 5, method 200 advances to step 215 of installing flooring 505 on floor F. Flooring 505, preferably is constructed of plywood (in practice, three 4×8×¾ sheets) that is appropriately sized to conform to a footprint of cargo area C generally defined by walls W, wheel wells H and doors D1 and D2. Supports or shims 513 may be interposed between flooring 505 and floor F to position flooring 505 at an appropriate height relative to floor F. Flooring 505 and supports 513 may be attached to floor F with glue or other appropriate installation convention.

Sizing of supports 513 is determined by whatever clearance is needed for installation on or relative to floor 505 of components such as, but not limited to, rollers 510, skid plates 515, stops 520 and other containment devices to receive and constrain the movement of caskets, stretchers, boxes, urns or other containers customarily or intended for transport in vehicle V.

Preferably, flooring 505 is configured with appropriately sized and arranged apertures 507 for receiving and maintaining bier pins 580 or other structures commonly used for securing caskets and the like.

After step 215, method 200 advances to step 220 of installing flooring covering 525 on flooring 505. Flooring covering 525 preferably is a laminate or other moisture- and abrasive-resistant material for transporting floral arrangements, flower racks, and funeral equipment without developing an unsightly appearance of flooring covering 525. Flooring covering 525 also should be resistant to penetration of bodily fluids, dirt and other materials that may be present in the transport of dead human bodies, and should be readily cleanable.

Method 200 then advances to step 225 of installing a partition 530 on flooring 505 between cargo area C and passenger area P. Partition 530 is intended to promote safety and provide a visual and atmospheric barrier between cargo area C and passenger area P. Partition 530, preferably, is constructed of ¾-inch plywood braced with wood 2×4′s, glued thereon with urethane and then reinforced with threaded fasteners. Preferably, partition 530 is constructed with storage trays (not shown).

As shown in FIG. 5, preferably, partition 530 includes a viewing section 537 that permits inspection of cargo area C from passenger area P. Viewing section 537, preferably, is constructed of glass or other opaque material, such as two-piece laminated safety glass.

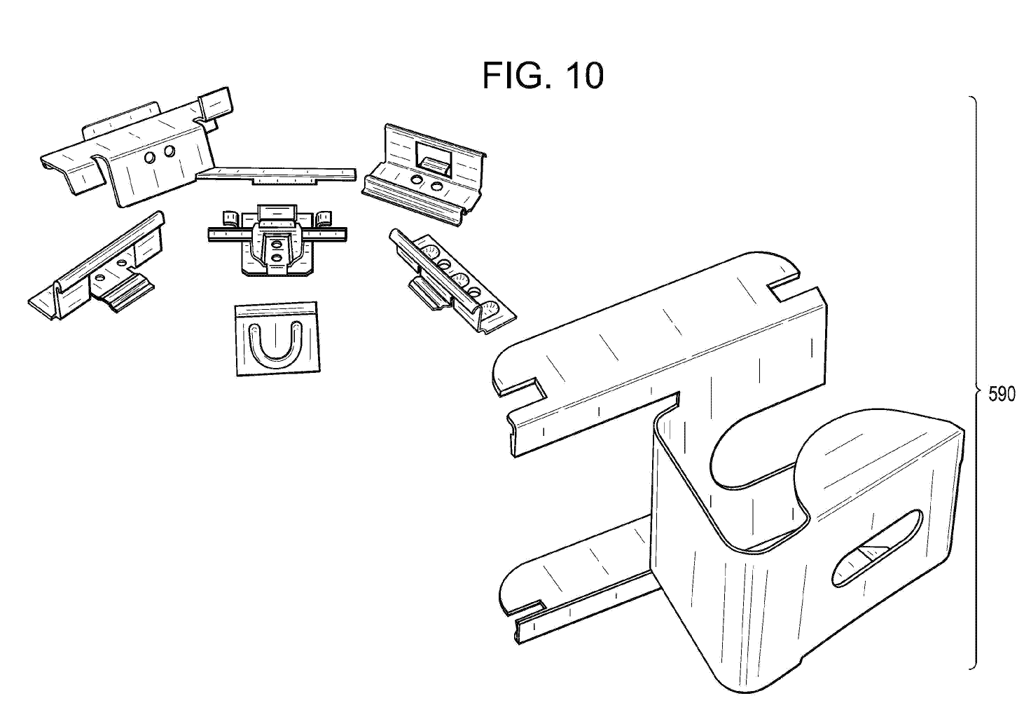

Partition 530 may be attached to flooring 505 with a steel clip system 590, preferably selected from those shown in FIG. 10, that permits removal as needed.

Partition 530, preferably, is covered with one or more of carpeting, metal and wood elements to enhance the appearance and protect from wear and tear of partition 530.

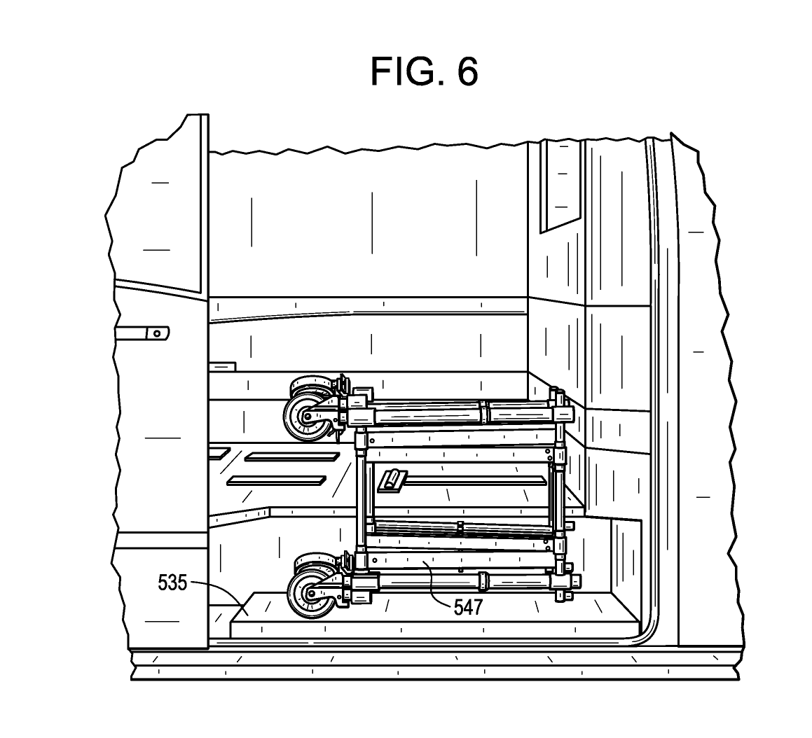

Referring also to FIG. 6, method 200 then advances to step 230 of covering sliding door well SDW with a sliding door well cover 535. Sliding door well cover 535, preferably, is constructed of carpet or other wear resistant material on which a casket truck 547 may be transported. A sliding door well sill plate (not shown), constructed of stainless steel or other durable material, may be installed on part of or entirely over sliding door well cover 535 or as a replacement thereof.

Referring again to FIGS. 2-5, method 200 then advances to step 235 of installing lighting 540 in roof R. Lighting 540 permits visibility and safe placement of casket stops, equipment, and stretcher loading and unloading when dark.

Method 200 then advances to step 240 of installing rear sill rollers 510 on floor F. The mounting component of rollers 510 and floor F may capture a portion of flooring 5 therebetween. Preferably, rollers 510 are eight ¾-inch rollers.

Method 200 then advances to step 245 of installing skid plates 515 and stops 520 on flooring 505.

Method 200 then advances to step 250 of installing rear door sill plates 545 on flooring 505. Rear door sill plates 545, preferably, are constructed of stainless steel and permit the loading and unloading of contents without damage to the container thereof or vehicle V.

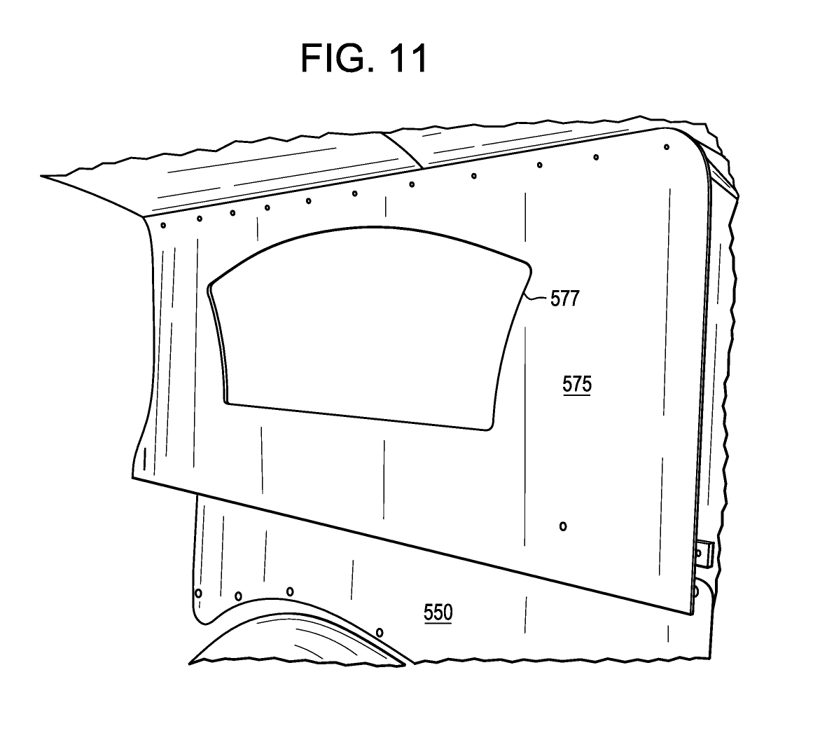

Referring also to FIG. 11, method 200 then advances to step 255 of installing interior panels 550 on lower portions of walls W and doors D1, D2. Panels 550 are padded and covered in carpeting with stainless steel and other trim and edging materials that enhance durability and present an appearance that is acceptable for its purpose to the public. Panels 550 are attached to walls W and doors D1 and D2 by a steel clip system comparable to that described with respect to partition 530 above.

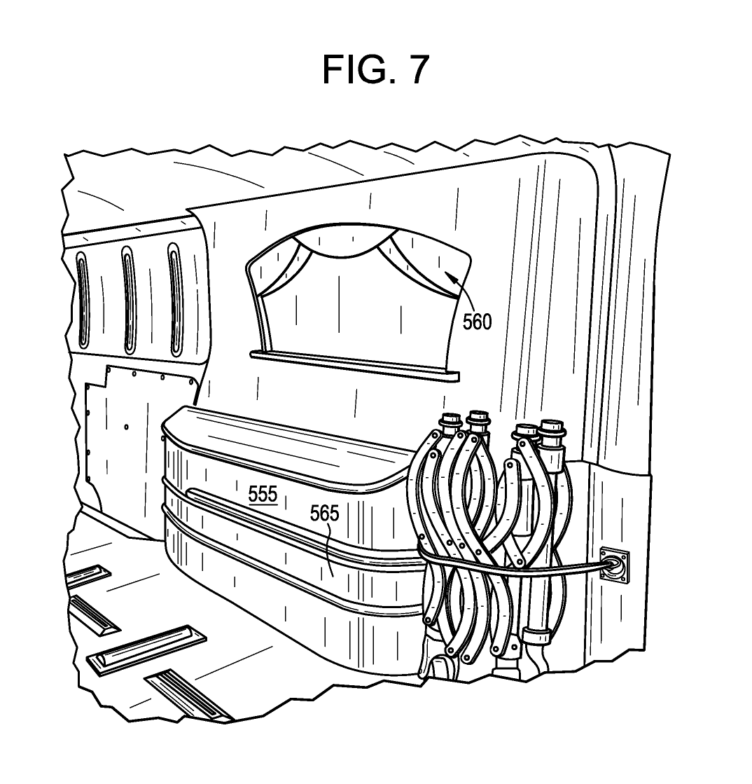

Referring to FIGS. 2, 3 and 7, method 200 then advances to step 260 of installing wheel well enclosures 555 over wheel wells H below interior panels 550. Wheel well enclosures 555, preferably, are constructed of a wood frame and ⅛-inch masonite, and configured to enclose wheel wells H. Wheel well enclosures 555 are attached to flooring 505 by a steel clip system comparable to that described with respect to partition 530 above.

Method 200 then advances to step 263 of installing wheel well enclosure coverings 570 on wheel well enclosures 555. Preferably, wheel well covers 570 include padding and exterior materials that are wear resistant and compliment the rest of the interior of cargo area C as converted.

Method 200 then advances to step 270 of installing bands 565 on wheel well enclosures 555 and partition 530. Bands 565, preferably, are constructed of stainless steel having a 6-inch width and are attached with threaded fasteners via ½-inch chrome edge strips. Bands 565 are wear resistant and maintain the appearance of the finished interior of vehicle V.

Referring also to FIG. 11, method 200 then advances to step 265 of installing shadow boxes 575 above interior panels 550. Shadow boxes 575, preferably, are constructed of wood, padded and covered with fabric comparable to or complementary of panels 550 and enclosures 555 and extend along an upper portion of walls W. Shadow boxes 575 essentially enclose the windows of vehicle V situated in cargo area C, which are covered, thus transmit no light, as described below. Accordingly, shadow boxes 575, preferably, include decorative lighting (not shown) within the space defined between walls W and shadow box 575 and a light-transmissive panel 577 to provide cargo area C with ambient lighting. Shadow boxes 575 attach to vehicle V with a steel clip system comparable to that described with respect to partition 530 above.

Referring to FIG. 5, method 200 then advances to step 275 of installing drapes 560 on shadow boxes 575 and over windows of rear doors D2. Drapes 560 provide for a more finished appearance and added privacy as needed.

Referring to FIG. 4, in addition to the components described above in connection with the foregoing method 200, kit 500 includes a foldable mat 585 constructed of carpeting or other protective material that is configured to extend at least partially over the rear bumper of vehicle, as shown in FIG. 5, to extend the protections afforded by rear door sill plates 545 and protect vehicle V from unsightly damage. Kit 500, preferably, also includes casket bier pins 580 appropriately configured to be received and maintained in flooring 505 and a casket truck 547.

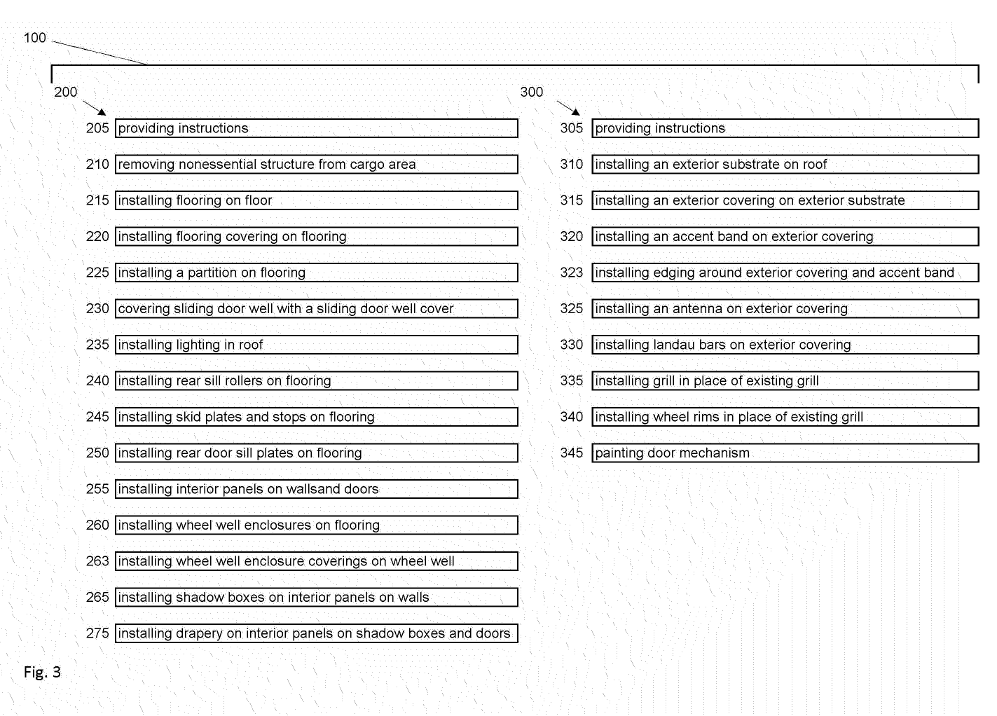

Referring to FIG. 3, method 300 for converting an exterior includes a step 305 of providing instructions 603 of a kit 601 for converting the vehicle. Instructions 603 explain method 300 as set forth herein.

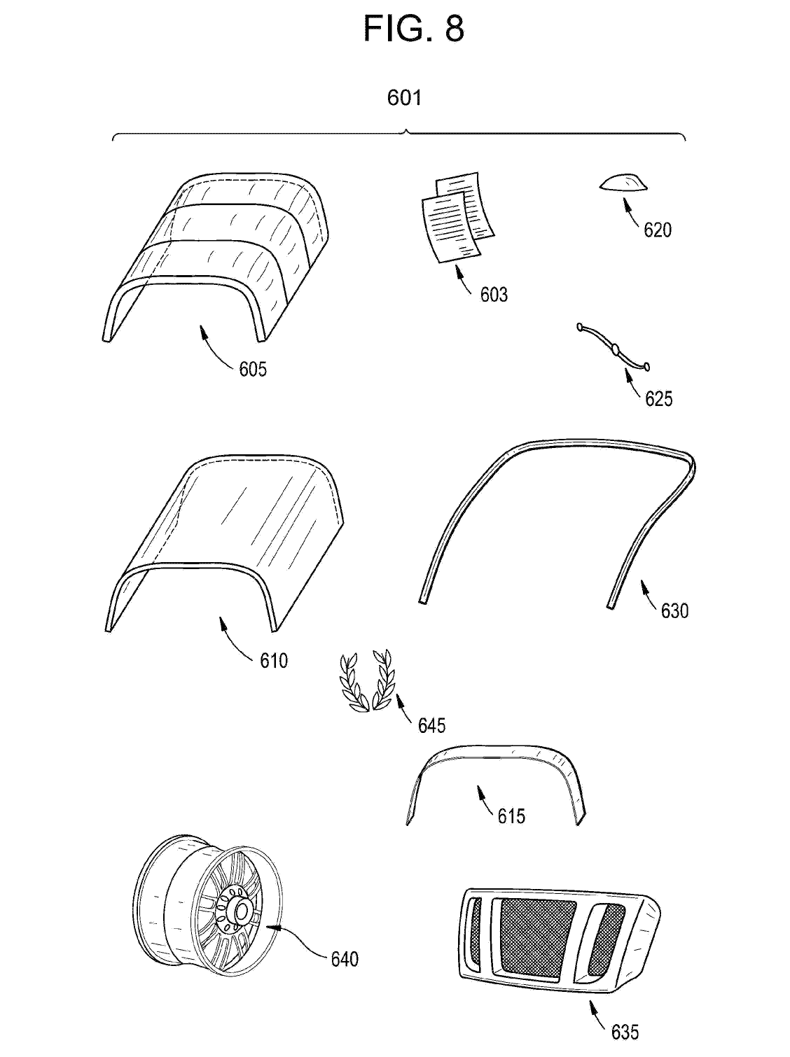

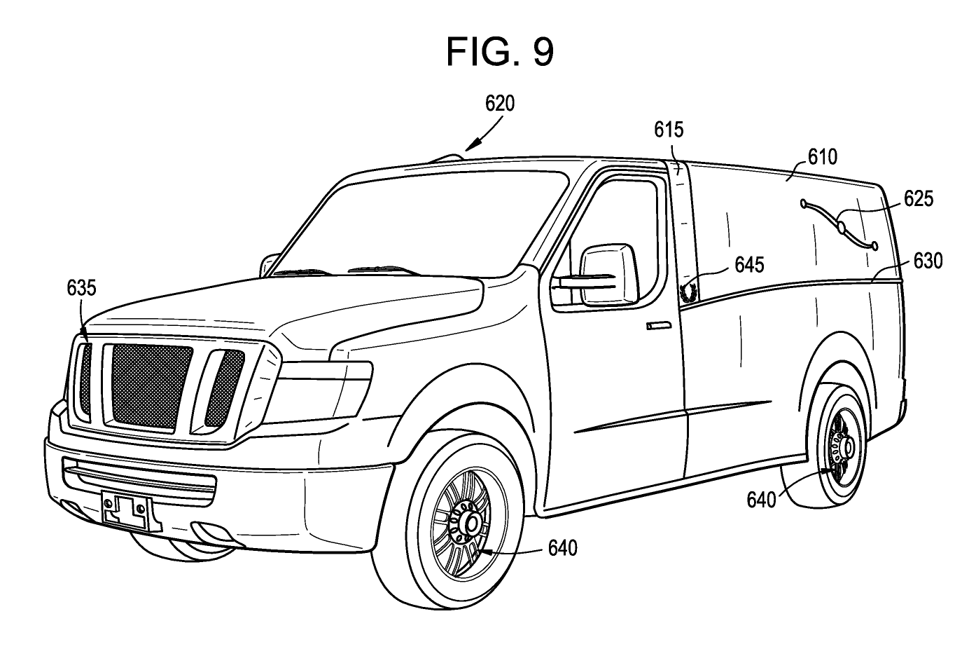

Referring also to FIGS. 8 and 9, method 300 then advances to step 310 of installing an exterior substrate 605 on roof R. Exterior substrate 605, preferably, is aluminum sheeting covered with a sufficient amount of padding to lend an attractive appearance to an overlaid exterior covering 610. In practice, exterior substrate 605 is constructed of three pieces of aluminum sheeting attached to roof R with urethane glue and 3M tape, and three additional fitted sheets of aluminum attached to the sides of vehicle V in similar fashion. One ¼-inch closed-cell foam padding is disposed on and glued to the aluminum sheeting in a manner that creates a smooth surface.

Method 300 then advances to step 315 of installing exterior covering 610 on exterior substrate 605. In practice, covering 610 is constructed of five sections of vinyl, stitched together, fitted, stretched and then glued over exterior substrate 605.

Method 300 then advances to step 320 of installing an accent band 615 on exterior covering 610. Accent band 615, preferably, is constructed of stainless steel. Accent band 615 conceals the vinyl seam and receives wreath identification badges 645.

Method 300 then advances to step 323 of installing edging 630 around exterior covering 610. Preferably, edging 630 is a ¼-inch aluminum strip that is attached with threaded fasteners around exterior covering 610 and the edges of accent band 615.

Method 300 then advances to step 325 of installing an antenna 620, preferably, on exterior covering 610. Preferably, antenna 620 is configured for reception of Sirius® radio reception.

Method 300 then advances to step 330 of installing landau bars 625 on exterior covering 610. Landau bars 625 are attached to the sides of vehicle V with bolts through holes drilled into the rear third of the roof sides.

Method 300 then advances to step 335 of installing a grill 635 in place of the factory-issued plastic grill shown in FIG. 1. Preferably, grill 635 is constructed of chromed metal or stainless mesh.

Method 300 then advances to step 340 of installing wheel rims 640 in place of the factory-issued standard painted wheel rims shown in FIG. 1. Preferably, wheel rims 640 are constructed of chromed metal.

Method 300 then advances to step 345 of painting the exterior sliding door mechanism to match a coloring and styling of the body of vehicle V.

Method 300 also may include installing: name plates, additional windows, strobe warning lights, pin striping, and stainless steel rocker covers.

The invention is not limited to the particular embodiments described and depicted herein, rather only to the following claims.

I claim:

1. Method of converting a vehicle having a cargo area with a floor, walls including windows, doors, wheel wells and a roof, comprising:
installing flooring on the floor; and
installing rollers on the floor and/or flooring.

2. Method of claim 1, further comprising, prior to said installing flooring, removing existing fixtures and trim from the cargo area.

3. Method of claim 1, further comprising installing on the flooring one or more of:
a covering;
a partition;
a wheel well enclosure;
a sill plate;
a skid plate; and
a stop.

4. Method of claim 3, further comprising one or more of:
following installing on the flooring a partition, installing a partition covering on the partition; and
following installing on the flooring a wheel well enclosure, installing a wheel well enclosure covering on the wheel well enclosure.

5. Method of claim 1, further comprising one or more of:
installing interior panels on the walls; and
installing interior panels on the doors.

6. Method of claim 1, further comprising installing on the roof one or more of:
lighting;
a substrate; and
a vinyl covering.

7. Method of claim 1, further comprising providing instructions for converting the vehicle.

8. Kit for converting a vehicle having a cargo area with a floor, walls including windows, doors, wheel wells and a roof, comprising:
a flooring configured to be coextensive with the floor; and
a set of rollers configured to be installed on the floor and/or flooring.

9. Kit of claim 8, further comprising one or more of:
a floor covering configured to be installed on said flooring;
a partition configured to be installed on the flooring;
a wheel well enclosure configured to be installed on the flooring;
a wall panel configured to be installed on one of the walls;
a door panel configured to be installed on one of the doors; and
a light configured to be installed on the roof.

10. Kit of claim 9, further comprising one or more of:
a partition covering configured to be installed on said partition; and
a wheel well enclosure covering configured to be installed on said wheel well enclosure;
a wall panel covering configured to be installed on said wall panel; and
a door panel covering configured to be installed on said door panel.

11. Kit of claim 9, further comprising one or more of:
a drapery configured to be installed on said wall panel; and
a shadow box configured to be installed on said wall panel.

12. Kit of claim 8, wherein said flooring is configured to receive a bier pin.

13. Kit of claim 12, further comprising a bier pin.
